(19) United States
(12) Patent Application Publication
(10) Pub. No.: US 2025/0303492 A1
(43) Pub. Date: Oct. 2, 2025

(54) METHOD AND SYSTEM FOR JOINING DISSIMILAR MATERIALS

(71) Applicant: Paul Po CHENG, London (CA)

(72) Inventor: Paul Po CHENG, London (CA)

(21) Appl. No.: 19/092,187

(22) Filed: Mar. 27, 2025

Related U.S. Application Data
(60) Provisional application No. 63/572,583, filed on Apr. 1, 2024.

(51) Int. Cl. B23K 20/06; B23K 103/00; B23K 103/18

(52) U.S. Cl. CPC B23K 20/06; B23K 2103/18; B23K 2103/52

(57) ABSTRACT

A method of joining first and second workpieces that include first and second materials. An intermediate plate located between the first and second workpieces and a heating element is positioned therebetween. The heating element is energized to heat a first heated portion of the first workpiece to a hot working temperature, and to heat the intermediate plate to a first preselected temperature at which the intermediate plate heats a second heated portion of the second workpiece to a second preselected temperature. One or both of the workpieces are subjected to a translocation motion to engage the workpieces, and one or both of the workpieces are subjected to an engagement motion while engaged, to subject the first heated portion to shearing and to adhere the first heated portion to the second heated portion, to bond the first and second workpieces together.

### CROSS-REFERENCE TO RELATED APPLICATION

This application claims the benefit of U.S. Provisional Patent Application No. 63/572,583, filed on Apr. 1, 2024, the entirety of which provisional patent application is hereby incorporated herein by reference.

### FIELD OF INVENTION

The present invention is a method and a system for joining dissimilar materials.

### BACKGROUND OF THE INVENTION

As is well known in the art, joining workpieces made of dissimilar materials (e.g., by welding or fusing them) can be difficult. For instance, in the prior art, a metal object made of steel or aluminum is generally not directly fusible or weldable to an object made of ceramic or composite material(s).

### SUMMARY OF THE INVENTION

For the foregoing reasons, there is a need for a method and a system that overcomes or mitigates one or more of the defects or deficiencies of the prior art.

In its broad aspect, the invention provides a method of joining a first workpiece including a first material and a second workpiece including a second material. An intermediate plate is located between the first and second workpieces to define a first gap between the first workpiece and the intermediate plate, in which a heating element is positioned. The heating element is energized to heat a first heated portion of the first workpiece to a hot working temperature, and to heat the intermediate plate to a first preselected temperature at which the intermediate plate heats a second heated portion of the second workpiece to a second preselected temperature. One or both of the workpieces are subjected to a translocation motion to engage the workpieces, and one or both of the workpieces are subjected to an engagement motion while engaged, to subject the first heated portion to shearing and to adhere the first heated portion to the second heated portion, to bond the first and second workpieces together.

### BRIEF DESCRIPTION OF THE DRAWINGS

The invention will be better understood with reference to the attached drawings, in which:

FIG. 1A is a cross-section of embodiments of first and second workpieces and an intermediate plate, with a heating element positioned between the first workpiece and the intermediate plate;

FIG. 1B is a cross-section of an assembly formed of the first and second workpieces of FIG. 1A, fused together;

FIG. 2A is a cross-section of the first workpiece and another embodiment of the second workpiece and an intermediate plate, with a heating element positioned between the first workpiece and the intermediate plate;

FIG. 2B is a cross-section of an assembly formed of the first and second workpieces of FIG. 2A, fused together;

FIG. 3 is a side view of an alternative embodiment of the first workpiece of the invention;

FIG. 3A is an end view of an alternative embodiment of the second workpiece of the invention;

FIG. 3B is a cross-section of the first and second workpieces of FIGS. 3 and 3A with an intermediate plate and a heating element located therebetween;

FIG. 3C is a cross-section of an assembly of the first and second workpieces of FIGS. 3, 3A, and 3B, fused together;

FIG. 3D is a cross-section of another embodiment of the workpieces with an intermediate plate and a heating element therebetween;

FIG. 3E is a cross-section of an assembly of the first and second workpieces of FIG. 3D, fused together;

FIG. 4A is an end view of another embodiment of the second workpiece;

FIG. 4B is a side view of the second workpiece of FIG. 4A;

FIG. 4C is an isometric view of a first workpiece and the second workpiece of FIGS. 4A and 4B, fused together;

FIG. 4D is a cross-section of the workpieces fused together with an alternative embodiment of the retaining ring positioned thereon;

FIG. 5A is an end view of an alternative embodiment of a second workpiece of the invention;

FIG. 5B is a side view of another embodiment of the intermediate plate of the invention;

FIG. 5C is an end view of an alternative embodiment of the first workpiece;

FIG. 6A is a top view of another embodiment of the second workpiece of the invention;

FIG. 6B is a side view of another embodiment of the first workpiece of the invention;

FIG. 7A is a side view of an alternative embodiment of a second workpiece and an intermediate plate and an isometric view of a first workpiece; and

FIG. 7B is an isometric view of the first and second workpieces of FIG. 7A.

### DETAILED DESCRIPTION

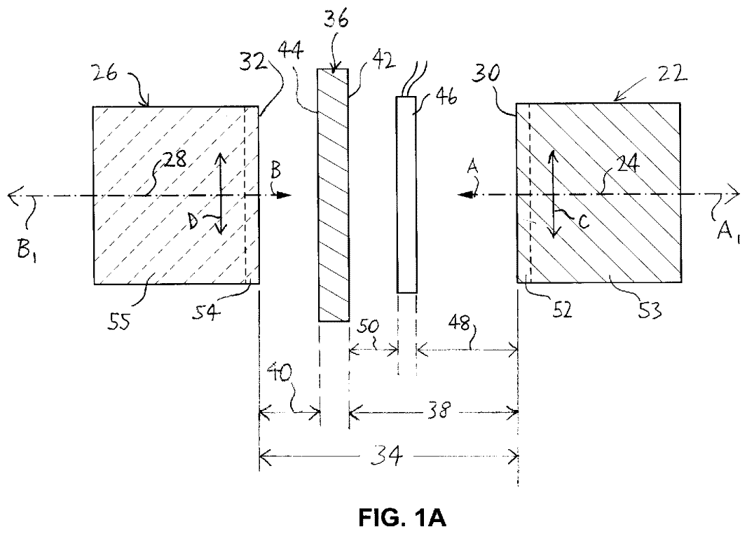

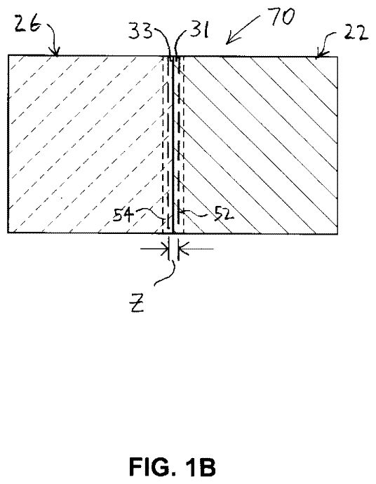

In the attached drawings, like reference numerals designate corresponding elements throughout. Reference is first made to FIGS. 1A and 1B to describe an embodiment of a method in accordance with the invention.

The method is for joining together a first workpiece 22 that includes a first material “M₁” with a first thermal conductivity and a second workpiece 26 that includes a second material “M₂” with a second thermal conductivity that is less than the first thermal conductivity. In one embodiment, the method includes, first, locating the first and second workpieces 22, 26 to position respective first and second surfaces thereof 30, 32 spaced apart to define a primary gap 34 therebetween.

Preferably, an intermediate plate 36 is located in the primary gap 34, to partially define a first gap 38 and a second gap 40. The first gap 38 is defined between a first side 42 of the intermediate plate 36 and the first surface 30 (FIG. 1A). As can be seen in FIG. 1A, the second gap 40 is defined between a second side 44 of the intermediate plate 36 and the second surface 32. As will be described, the intermediate plate preferably includes a third material “M₃” with a third thermal conductivity that preferably is equal to or greater than the first thermal conductivity.

It will be understood that the first material “M₁” may be any suitable metal (e.g., aluminum). The second material “M₂” may also be any suitable material, e.g., a ceramic material, or a composite material with suitable properties, e.g., zirconium diboride (ZrBr₂). Also, the third material “M₃” preferably is any suitable material, e.g., aluminum, copper, steel, or titanium.

As noted above, the first material “M₁” preferably has a first thermal conductivity that is greater than a second thermal conductivity of the second material “M₂”. For example, the first material “M₁” may be aluminum or an alloy thereof, e.g., having a first thermal conductivity of approximately 150-220 W/mK or more. The second material “M₂” may be a ceramic, e.g., zirconium diboride, with a second thermal conductivity of approximately 57.9 W/mK or less.

The third material “M₃” may be, for example, the same as the first material. Alternatively, the third material may be any material having a thermal conductivity equal to or greater than the thermal conductivity equal to or greater than the thermal conductivity of the first material. For instance, the third material may be copper, with a thermal conductivity of approximately 401 W/mK.

It is also preferred that the melting temperatures of the first, second, and third materials “M₁”, “M₂”, “M₃” are compatible. For example, the melting temperature of the first material “M₁” preferably does not exceed the melting temperature of the second material “M₂”. Also, the melting temperature of the third material “M₃” preferably does not exceed the melting temperature of the second material “M₂”.

In one embodiment, one or more heating elements 46 preferably are located in the first gap 38. As will be described, in the first gap 38, the heating element(s) 46 preferably are positioned a first preselected distance 48 apart from the first surface 30, and a second preselected distance 50 apart from the first side 42 of the intermediate plate 36.

Next, the one or more heating elements 46 are energized, to heat a first heated portion 52 of the first workpiece 22 in an inert atmosphere to a hot working temperature, at which the first heated portion 52 is plastically deformable. The one or more heating elements 46 also heat the intermediate plate 36 to a first preselected temperature, at which the heated intermediate plate 36 heats a second heated portion 54 of the second workpiece 26 in an inert atmosphere to a second preselected temperature.

As can be seen in FIGS. 1A and 1B, the first workpiece 22 includes a first body portion 53 thereof that is not initially heated to the hot working temperature. The first body portion 53 is the portion of the first workpiece 22 that does not include the first heated portion 52. However, those skilled in the art would appreciate that, once the first heated portion 52 has been heated to the hot working temperature, heat energy dissipates from the first heated portion 52 into the first body portion 53.

The second workpiece 26 includes a second body portion 55 that is not initially heated to the second preselected temperature. The second body portion 55 is the portion of the second workpiece 26 that does not include the second heated portion 54. However, those skilled in the art would appreciate that, once the second heated portion 54 has been heated to the second preselected temperature, heat energy dissipates from the second heated portion 54 into the second body portion 55.

Those skilled in the art would appreciate that the hot working temperature is slightly less than a melting temperature of the first material “M₁”. For example, the hot working temperature may be approximately 90% to 95% of the melting temperature of the first material “M₁”. When the first material “M₁” is at the hot working temperature, the first material is plastically deformable.

Those skilled in the art would also appreciate that, where the second workpiece 26 is made of a ceramic material (e.g., zirconium diboride), its melting point may be very high, e.g., approximately 3,200° C. In contrast, where the first workpiece 22 is made of aluminum, the melting point thereof is approximately 660° C. The third material may be, e.g., copper, with a melting point of approximately 1,085° C.

As will be described, the heating element(s) 46 and the intermediate plate 36 preferably are positioned relative to the first and second workpieces 22, 26 so as to achieve the desired result, i.e., heating the first heated portion 52 to the hot working temperature, and heating the second heated portion 54 to the second preselected temperature.

Those skilled in the art would be aware of suitable inert (i.e., non-oxidizing) atmosphere. Those skilled in the art would also be aware of methods and means for maintaining an inert atmosphere in place, e.g., over the intermediate plate and the heated portions, during heating. It will be understood that the inert atmosphere and means for maintaining the inert atmosphere in place are omitted from the drawings herein, for clarity of illustration.

It will also be understood that the one or more heating elements 46 may be any suitable heating elements. For instance, the one or more heating elements 46 may be configured for heating the first heated portion 52 by induction, and also for heating the intermediate plate 36 by induction.

Those skilled in the art would also appreciate that, where the second workpiece 26 is made of a ceramic material, the second heated portion 54 may be heated by radiation of heat energy or, alternatively, via conduction of heat energy, from the intermediate plate 36 to the second heated portion. In one embodiment, the second heated portion 54 may be preheated.

Once the first and second heated portions 52, 54 are at the hot working temperature and at the second preselected temperature respectively, the intermediate plate 36 and the one or more heating elements 46 are removed from the primary gap 34. It is preferred that such removal is effected quickly.

In one embodiment, while the first heated portion 52 is at the hot working temperature and the second heated portion 54 is at the second preselected temperature, one or both of the first and second workpieces 22, 26 preferably are subjected to a translocation motion to move the first and/or the second workpieces together, to engage the first and second surfaces 30, 32 with each other. For instance, as can be seen in FIG. 1A, the first workpiece 22 may be moved in the direction indicated by arrow “A”, and/or the second workpiece 26 may be moved in the direction indicated by arrow “B”, until the first and second surfaces 30, 32 are engaged with each other (FIG. 1B).

Next, while the first heated portion 52 is at the hot working temperature and the second heated portion 54 is at the second preselected temperature, and while the first and second surfaces 30, 32 are engaged with each other, one or both of the first and second workpieces 22, 26 are subjected to an engagement motion. As will be described, when one or both of the workpieces 22, 26 are subjected to the engagement motion, the one or more workpieces that are subjected to the engagement motion move relative to the other workpiece. For example, the first workpiece 22 may be moved in the directions indicated by arrow “C” relative to the second workpiece 26, and/or the second workpiece 26 may be moved in the directions indicated by arrow “D”, relative to the first workpiece 22, while the first and second surfaces 30, 32 are engaged. The engagement motion may be regularly repeated, or otherwise.

As will be described, in an alternative embodiment, the engagement motion may commence before the first and second surfaces 30, 32 are engaged. It will be understood that arrows “C” and “D” are included in FIG. 1A for clarity of illustration.

As noted above, when the first heated portion 52 is at the hot working temperature, the first heated portion 52 is plastically deformable.

The heated portion 52 preferably is at least partially subjected to shearing when the workpieces 22, 26 are subjected to the engagement motion, due to engagement of the first and second heated portions 52, 54 during the engagement motion of one or both of the workpieces 22, 26. Preferably, the first heated portion 52 at least partially bonds to the second heated portion 54 and remains bonded thereto upon cooling.

It is believed that only very small parts of the first and second heated portions 52, 54 (in the form of layers) are bonded together. Because only very thin layers of the first and second heated portions 52, 54 are joined together, the bond created is a “skin effect” bond, i.e., not extending into the heated portions beyond a very shallow depth. It will be understood that a part or layer 31 of the first heated portion 52 that is at least partially bonded to the second heated portion 54 may be very small, e.g., the part 31 may be a thin layer only a few atoms thick at the first surface 30. It is believed that, while the workpieces 22, 26 are engaged and one or more of them is subjected to the engagement motion, the small part 31 of the first heated portion 52 becomes intermingled with a small part or layer 33 of the second heated portion 54 that may be only a few atoms thick at the second surface 32, thereby forming a bond between the first and second heated portions 52, 54. The mechanism resulting in the bonding of the workpieces 22, 26 together is not well understood. It is believed that, at the atomic level, because the first material “M₁” is at its hot working temperature and plastically deformable, and the second material “M₂” is also at an elevated temperature, the atoms in the part 31 are pressed into such openings as exist in the crystalline structure of “M₂”. It is also understood, however, that the materials “M₁”, “M₂” are generally not complementary, at a subatomic level. In summary, the first heated portion 52 is at least partially subjected to shearing, and adheres to the second heated portion 54, to bond the first and second workpiece together.

When the workpieces are bonded together, the small parts 31, 33 define a very narrow bonded zone “Z” (FIG. 1B) across which the first and second workpieces 22, 26 are bonded together.

It will be understood that the widths of the respective parts 31, 33 as illustrated in FIG. 1B are exaggerated, for clarity of illustration.

From the foregoing, it can be seen that the bond formed across the bonded zone “Z” is mechanical in nature (at a subatomic level), rather than chemical. Among other things, this means that engaging more of the respective surface areas of the workpieces (i.e., when the first heated portion is at the hot working temperature and the second heated portion is at the second predetermined temperature) results in a better bond between the first and second workpieces.

Because the bonded zone “Z” is very narrow, this means that residual stresses are minimized in the process of the invention. In contrast, for example, in friction welding, the workpieces are heated to a melting temperature thereof to a significant depth. As is know in the art, friction welding disadvantageously involves subjecting the joined workpieces to internal stresses when heating at depth takes place and residual stresses also result when the workpieces that have been joined by friction welding are cooled.

The method of the invention generally avoids subjecting the workpieces to such residual stresses because the bonded zone “Z” is very thin.

In the example illustrated in FIG. 1A, the intermediate plate 36 is heated by the one or more heating elements 46, and in turn the heated intermediate plate 36 heats the second heated portion 54, preferably via radiation of heat energy therefrom. It will be understood that the intermediate plate 36 may have any suitable shape or configuration.

From the foregoing, it can be seen that the intermediate plate 36 preferably is heated only in order to bring the second heated portion 54 to the second preselected temperature. As is well known in the art, certain ceramic material is a poor conductor of thermal energy, but aluminum is a very good conductor of thermal energy. In one embodiment, the method of the invention takes advantage of this difference in thermal conductivities, e.g., where the first workpiece is made of aluminum and the second workpiece is made of zirconium diboride.

Because of the difference in thermal conductivities, heat is dissipated from the first heated portion 52 into the first body portion 53 relatively quickly, but heat is not dissipated from the second heated portion 54 into the second body portion 55 as quickly. As described above, while the first heated portion 52 is at the hot working temperature and the second heated portion 54 is at the second preselected temperature, the first and second surfaces 30, 32 are engaged, and one or both of the first and second workpieces 22, 26 are subjected to the engagement motion. When the first and second surfaces 30, 32 are engaged, heat energy may be transferred by conduction from the second workpiece 26 to the first workpiece 22, or vice versa, depending on differences in temperature thereof, if any.

From the foregoing, it can be seen that, while the first and second surfaces 30, 32 are engaged, and while the first and second heated portions 52, 54 are at hot working temperature and the second preselected temperature respectively, the engagement motion takes place.

Those skilled in the art would appreciate that the engagement motion may take place for only a very short time period. It will be understood that, shortly after the respective small parts 31, 33 of the first and second heated portions are engaged, sufficient heat has dissipated that the first heated portion 52 is no longer at the hot working temperature. At that point, the first and second workpieces 22, 26 are bonded together, and the engagement motion has ended.

Preferably, first and third melting points of the first and third materials “M₁”, “M₃” are both less than a second melting point of the second material “M₂”. It is also preferred that the first melting point is less than the second melting point.

For example, the first, second, and third materials “M₁”, “M₂”, and “M₃” may be the following respective materials (as outlined above), having the respective melting points as set out below:
Aluminum (“M₁”)—melting point: approximately 660° C.;
Zirconium diboride (“M₂”)—melting point: approximately 3,245° C.;
Copper (“M₃”)—melting point: approximately 1,085° C.

As noted above, the hot working temperature preferably is slightly below the melting point of the first material “M₁”, i.e., it is a temperature at which the first heated portion is plastically deformable. It will be understood that the first and second preselected temperatures are approximately the same as, or slightly less than, the hot working temperature. Accordingly, it can be seen that in this example, when the first and second workpieces 22, 26 are engaged with each other, the first and second surfaces 30, 32 are at approximately the same temperature. Those skilled in the art would appreciate that there is therefore unlikely to be significant heat transfer between the first and second workpieces.

As noted above, the first and second workpieces 22, 26 preferably are engaged, and subjected to the engagement motion, while the first heated portion 52 and the second heated portion 54 are at the hot working temperature and the second preselected temperature respectively. The first heated portion is, while at the hot working temperature, subjected to plastic deformation. Preferably, when the workpieces are subjected to the engagement motion, the workpieces are urged against each other, in the directions indicated by arrows “A” and “B” in FIG. 1A, causing at least the small part 53 of the first heated portion 52 to adhere to and to bond with at least the small part 55 of the second heated portion 54, as described above.

Those skilled in the art would appreciate that the heat energy in the first and second heated portions 52, 54 dissipates therefrom relatively quickly, following engagement.

It will be understood that the respective locations of the intermediate plate 36 and the heating elements 46 relative to the first and second surfaces 30, 32 preferably are determined so as to maximize efficiency. Once the first and second heated portions 52, 54 are at the hot working temperature and the second preselected temperature respectively, and preferably while the first and second workpieces 22, 26 are subjected to the engagement motion, the workpieces 22, 26 preferably are pushed against each other, to cause the surfaces 30, 32 to be urged against each other (i.e., forged), as shown in FIGS. 1A and 1B.

Those skilled in the art would appreciate that references herein to a “hot working temperature” should be understood to possibly refer to a range of temperatures (i.e., not necessarily a single temperature) at which the first heated portion is plastically deformable. However, the term “hot working temperature” may refer to a single temperature, depending on the context.

As can be seen in FIG. 1A, in one embodiment, the first and second workpieces 22, 26 preferably define respective first and second axes 24, 28 thereof. In one embodiment, the engagement motion preferably includes rotation of one or both of the workpieces 22, 26 about the respective axes 24, 28 thereof. It is also preferred that the first and second workpieces 22, 26 are positioned coaxially.

As noted above, after the heating element 46 and the intermediate plate 36 are removed from the gap 34, one or both of the workpieces 22, 26 may be moved toward the other in the translocation motion, for engagement of the first and second workpieces 22, 26. For clarity of illustration, in FIG. 1A, arrow “A” indicates a direction of movement of the first workpiece 22 toward the second workpiece 26, and arrow “B” indicates a direction of movement of the second workpiece 26 toward the first workpiece 22.

In one embodiment, as illustrated in FIG. 1A, the first and second surfaces 30, 32 preferably are substantially planar. However, the first and second surfaces 30, 32 may have any suitable configurations. The surfaces 30, 32 preferably are formed to complement or mate with each other.

In another embodiment, when the first and second heated portions 52, 54 are at the hot working temperature and the second preselected temperature respectively (and after the heating element 46 and the intermediate plate 36 are removed from the gap 34), one or both of the workpieces 22, 26 preferably are subjected to axial oscillation while the first and second heated portions 52, 54 are engaged, or partially engaged. In this embodiment, instead of rotation of one or both of the workpieces about their respective axes while the first and second heated portions 52, 54 are engaged, one or both of the workpieces 22, 26 are subjected to the axial oscillation.

For example, while the second workpiece 26 is held stationary (and while the heated portions 52, 54 are at the hot working temperature and the second preselected temperature respectively), the first workpiece 22 may be moved axially, in the direction indicated by arrow “A”, to urge the first heated portion 52 against the second heated portion 54. Shortly after the initial engagement, the first workpiece 22 is moved in the direction indicated by arrow “A₁”, i.e., to briefly relieve the pressure exerted against the second heated portion 54 by the first heated portion 52 (FIG. 1A). However, it is preferred that the first heated portion 52 is not fully disengaged from the second heated portion 54 when the first workpiece 22 is moved in the direction indicated by arrow “A₁”.

Alternatively, the second workpiece 26 may be subjected to axial oscillation. As noted above, the axial oscillation preferably takes place after the first and second heated portions are heated to the hot working temperature and the second preselected temperature respectively, and after the heating element and the intermediate plate have been removed. In this embodiment, while the first workpiece 22 is held stationary (and while the heated portions 52, 54 are at the hot working temperature and the second preselected temperature respectively), the second workpiece 26 may be moved axially, in the direction indicated by arrow “B”, to urge the second heated portion 54 against the first heated portion 52. Shortly after the initial engagement, the second workpiece 26 preferably is moved in the direction indicated by arrow “B₁”, i.e., to briefly relieve the pressure exerted against the first heated portion 52 by the second heated portion 54. However, it is preferred that the second heated portion 54 is not fully disengaged from the first heated portion 52 when the second workpiece 26 is moved in the direction indicated by arrow “B₁”.

In yet another embodiment, both of the workpieces 22, 26 may be subjected to axial oscillation.

From the foregoing, it can be seen that shearing of parts of the engaged first and second heated portions may be achieved by any motion or one or both of the workpieces relative to the other while they are engaged, e.g., by rotation of one or both of the workpieces about their respective axes, or by axial oscillation of one or both of the workpieces.

In effect, in these embodiments, the relative axial movement (i.e., axial oscillation) of one or both of the workpieces 22, 26 while the heated portions are engaged causes the small part 31 of the first heated portion 52 to be mixed with the small part 33 of the second heated portion 54, at the atomic level, similar to the mixing or intermingling of materials believed to be achieved upon engagement of the first and second heated portions 52, 54 while one or both of the workpieces are rotating, as described above.

During axial oscillation, different amounts of force may be applied throughout the process, urging the workpieces together, for predetermined time intervals, which are separated by preselected time periods. Also, the predetermined time intervals and preselected time periods may vary throughout the process.

In yet another embodiment, the axial oscillation described above may be combined with the rotation and engagement of the first and second workpieces, for shearing, to bond the first and second workpieces together.

As illustrated in FIG. 1B, the first and second workpieces 22, 26 preferably are fused or bonded together to form an assembly 70.

As described above, in one embodiment, the engagement motion may commence upon engagement of the first and second surfaces 30, 32. However, in an alternative embodiment, one or both of the workpieces 22, 26 may be subjected to the engagement motion prior to engagement of the first and second surfaces 30, 32.

For instance, immediately after the intermediate plate 36 is removed from the primary gap 34 (i.e., once the first and second heated portions are at the hot working temperature and the second preselected temperature respectively), one or both of the first and second workpieces 22, 26 may be subjected to the engagement motion, i.e., before one or both of the first and second workpieces 22, 26 are subjected to the translocation motion. In this embodiment, after the translocation motion commences, the engagement motion continues. Preferably, the engagement motion also continues, unchanged (or substantially unchanged), upon engagement of the first and second surfaces 30, 32, until the first and second workpieces are bonded together.

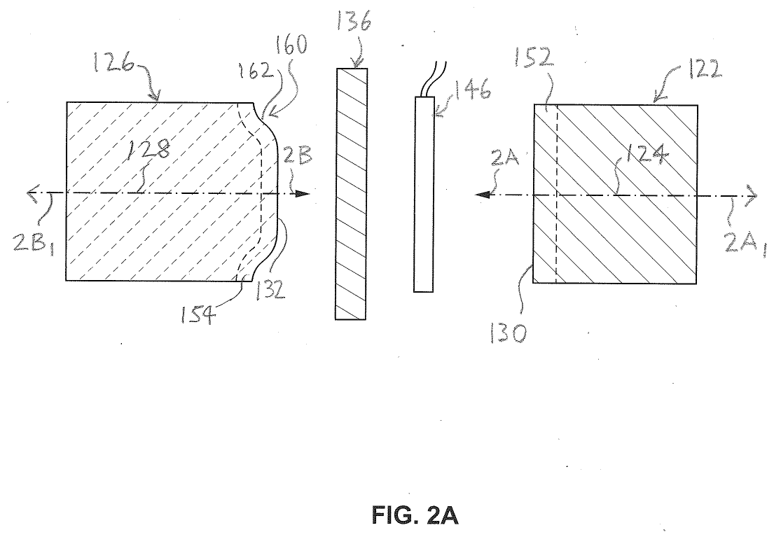

As noted above, bonding a metal and a ceramic together is generally difficult to achieve, due to the dissimilar properties and characteristics of the respective materials. In an alternative embodiment of the method of the invention, illustrated in FIGS. 2A and 2B, one or more slots or grooves 160 preferably is formed in a second workpiece 126. The purpose of the groove 160 is to provide more surface areas for engagement of the first and second workpieces 122, 126 with each other, thereby promoting bonding.

As can be seen in FIG. 2A, in one embodiment, the groove 160 preferably is partially defined by a curved outer wall 162 and a curved second surface 132 of the second workpiece 126. In one embodiment, the groove 160 preferably is at least partially defined by a generally rounded concave surface, to promote bonding. The groove 160 preferably is also partially defined by a ring 164 (FIG. 2B), as will be described.

It is preferred that first and second heated portions 152, 154 of the first and second workpieces 122, 126 are heated to the hot working temperature and the second preselected temperature respectively, in the same manner as described above, utilizing one or more heating elements 146 and an intermediate plate 136 positioned as shown in FIG. 2A. The first and second workpieces 122, 126 may be made of a suitable metal and a suitable ceramic, respectively. It will be understood that, as outlined above, when it is at the hot working temperature, the first heated portion 152 is plastically deformable. On the other hand, although the second heated portion 154 is heated to the second preselected temperature, the second heated portion 154 is not plastically deformable.

In substantially the same manner as described above, once the first and second heated portions 152, 154 have been heated to the hot working temperature and the second preselected temperature respectively, the intermediate plate 136 and the heating elements 146 are withdrawn from between the first and second workpieces 122, 126.

Preferably, while the first and second heated portions 152, 154 are at the hot working temperature and the second preselected temperature respectively, the workpieces 122, 126 are pushed together as indicated by arrows “2A” and “2B” in FIG. 2A. As described above, one or the other or both of the workpieces 122, 126 may be moved toward the other, for engagement of the workpieces 122, 126 with each other. When the workpieces 122,126 are brought together, a first surface 130 of the first workpiece 122 initially engages the second surface 132 of the second workpiece 126.

As noted above, the engagement motion may be any suitable motion, regularly repeated (at time intervals) or otherwise. It will be understood that, in one embodiment, one or both of the workpieces 122, 126 may be rotated about their respective axes 124, 128 before engagement. Because the first heated portion 152 is at the hot working temperature, the first heated portion 152 is at least partially plastically deformable. The second heated portion 154 is at the second preselected temperature. As illustrated in FIG. 2B, upon engagement, parts 166 of the first heated portion 152 preferably are squeezed into the groove 160. It can be seen in FIG. 2B that the parts 166 are held in position in the groove 160, at least in part, by the ring 164.

As illustrated in FIG. 2B, the ring 164 preferably is formed and positioned to hold the plastically deformed material in the groove 160. It will be understood that the ring 164 preferably is moved into position to be aligned with the groove 160 before the first and second surfaces 130, 132 are engaged with each other.

The first heated portion 152 preferably is at least partially subjected to shear by rotating one or both of the workpieces about their respective axes 124, 128 while the first and second workpieces 122, 126 are engaged with each other, while the first and second heated portions 152, 154 are at the hot working temperature and the second preselected temperature respectively. Preferably, the first heated portion 152 at least partially bonds to the second heated portion 154 and remains secured thereto upon cooling. It will be understood that a part 131 of the first heated portion 152 that is at least partially bonded to the second heated portion 154 may be very small, e.g., such part may be a thin layer only a few atoms thick at the first surface 130. It is believed that, while the workpieces 122, 126 are engaged and rotated, such small part 131 of the first heated portion 152 becomes intermingled with a small part 133 of the second heated portion 154 that may be only a few atoms thick at the second surface 132, thereby forming a bond between the first and second heated portions 152, 154. It will be understood that the sizes of the parts 131, 133 as illustrated in FIG. 2B are exaggerated for clarity of illustration.

It will be understood that the workpieces 122, 126 may, alternatively, be bonded together utilizing axial oscillation, generally as described above. In one embodiment, when the first and second heated portions 152, 154 are at the hot working temperature and the second preselected temperature (and after the heating element and the intermediate plate have been removed), the first workpiece 122 may be urged against the second workpiece 126 (i.e., the first workpiece 122 may be pushed in the direction indicated by arrow “2A” against the second workpiece 126). After such brief engagement, the first workpiece 122 preferably is moved in the direction indicated by arrow “2A₁”, however, without fully disengaging from the second workpiece 126. This procedure preferably is repeated while the first heated portion remains plastically deformable.

Alternatively, when the first and second heated portions 152, 154 are at the hot working temperature, the second workpiece 126 may the urged in the direction indicated by arrow “2B”, against the first workpiece 122. After brief engagement thereof, the second workpiece 126 preferably is moved in the direction indicated by arrow “2B₁” briefly, without fully disengaging.

It will also be understood that, in an alternative embodiment, both of the workpieces 122, 126 may be axially oscillated (e.g., at the substantially the same time), while the first and second heated portions 152, 154 are at the hot working temperature and the second preselected temperature respectively.

When the workpieces are bonded together, the small parts 131, 133 define a bonded zone “2Z” (FIG. 2B) across which the first and second workpieces 122, 126 are bonded together.

In yet another embodiment, the axial oscillation described above may be combined with rotation and engagement of the first and second workpieces, for bonding the first and second workpieces together.

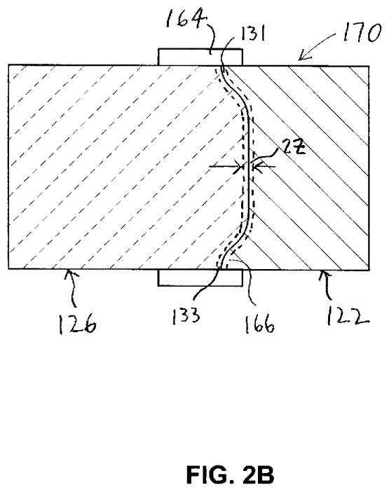

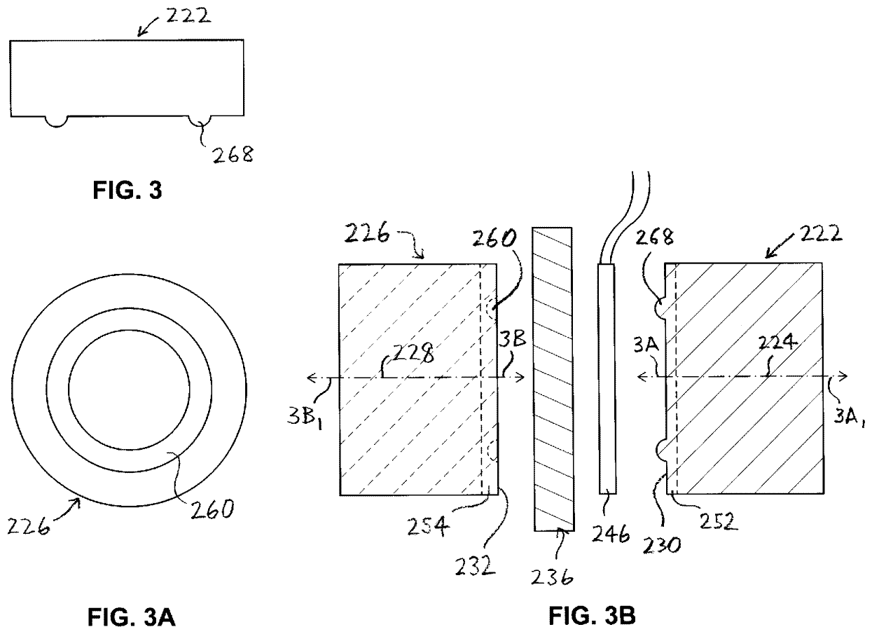

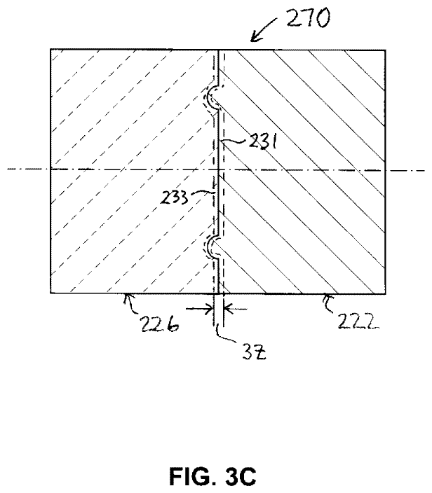

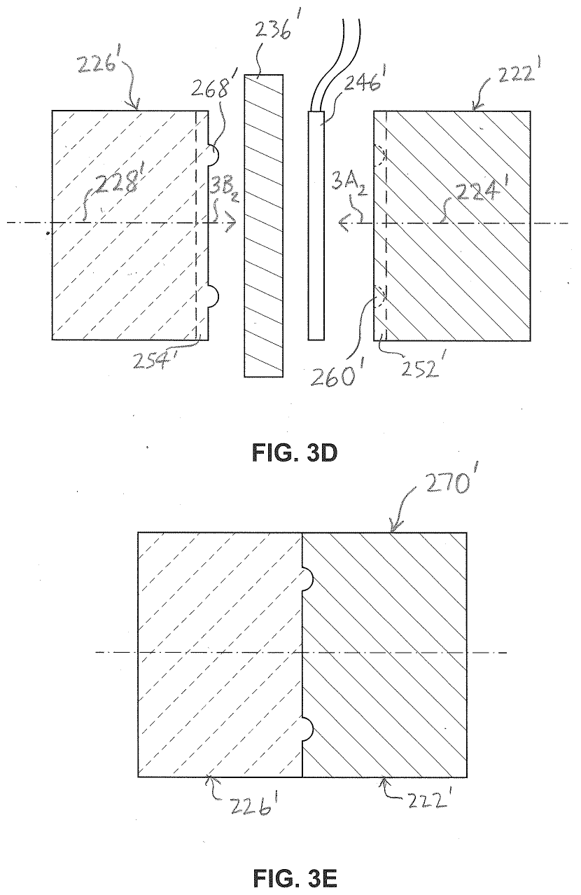

In another alternative embodiment, illustrated in FIGS. 3-3C, the first workpiece 222 preferably includes protruding elements 268 that fit into one or more grooves 260 in the second workpiece 226. Preferably, first heated portion 252 of the first workpiece 222 is heated to a hot working temperature of the metal of the first workpiece by the heating element 246, in substantially the same manner as described above (FIG. 3B). It is preferred that the second heated portion 254 of the second workpiece 226 is heated to the second preselected temperature by the intermediate plate 236.

It will be understood that the protruding elements 268 may have any suitable shape. In one embodiment, the protruding element 268 preferably has a shape that is complementary to the groove 260, but formed for engagement in the groove, as will be described. As will also be described, when the first and second workpieces 222, 226 are engaged with each other, the elements 268 preferably are at least partially located in the grooves 260. Due to the engagement of the protruding element 268 with the walls of the groove 260, the extent of the areas of each of the first and second workpieces 222, 226 that are engaged with each other is thereby increased.

Once the first heated portion 252 and the second heated portion 254 are at the hot working temperature and the second preselected temperature respectively, and preferably while one or both of the first and second workpieces 222, 226 are rotating about their respective axes 224, 228, the first and second workpieces 222, 226 are pushed together, i.e., one or both of the first and second workpieces 222, 226 are subjected to a translocation motion.

The first heated portion 252 (which includes the protruding elements 268) preferably is partially subjected to shearing when the first and second heated portions are at the hot working temperature and the second preselected temperature respectively and engaged, and one or both of the workpieces 222, 226 are rotated about their respective axes 224, 228. The grooves 260 preferably are at least partially located in the second heated portion 254. Preferably, the protruding element 268 fits into the groove in an interference or friction fit, resulting in the protruding element 268 being subjected to shearing, to an extent, when the first and second heated portions 252, 254 are engaged. It is also preferred that the first heated portion 252 at least partially bonds to the second heated portion 254 and remains secured thereto upon cooling. It will be understood that a part 231 of the first heated portion 252 that is at least partially bonded to the second heated portion 254 may be very small, e.g., such part may be a thin layer only a few atoms thick. It is believed that, while the workpieces 322, 326 are engaged and rotated, the small part 231 of the first heated portion 252 becomes intermingled with a small part 233 of the second heated portion 254 that may be only a few atoms thick, thereby forming a bond between the first and second heated portions (FIG. 3C). As a result, the first and second workpieces 222, 226 preferably are fused together to form an assembly 270 (FIG. 3C).

It will be understood that the extent of the parts 231, 233, as illustrated in FIG. 3C, is exaggerated for clarity of illustration.

In another embodiment, when the first and second heated portions 252, 254 are at the hot working temperature and the second preselected temperature respectively, one or both of the workpieces 222, 226 preferably are subject to axial oscillation while the first and second heated portions 252, 254 are engaged, or partially engaged. In this embodiment, instead of rotation of one or both of the workpieces about their respective axes while the first and second heated portions 252, 254 are engaged, one or both of the workpieces 222, 226 are subjected to the axial oscillation, while the first and second heated portions are engaged.

For example, while the second workpiece 226 is held stationary (and while the heated portions 252, 254 are at the hot working temperature and the second preselected temperature respectively), the first workpiece 222 may be moved axially, in the direction indicated by arrow “3A”, to urge the first heated portion 252 against the second heated portion 254. Shortly after the initial engagement, the first workpiece 222 is moved in the direction indicated by arrow “3A₁”, i.e., axially, to briefly relieve the pressure exerted against the second heated portion 254 by the first heated portion 252. However, it is preferred that the first heated portion 252 is not, by the movement in the direction indicated by arrow “3A₁”, fully disengaged from the second heated portion 254. Such axial engagement and relief of pressure may be repeated, to effect an oscillation.

Alternatively, the second workpiece 226 may be subjected to axial oscillation. The axial oscillation preferably takes place after the first and second heated portions are heated to the hot working temperature and the second preselected temperature respectively, and the heating element and the intermediate plate have been removed. In this embodiment, while the first workpiece 222 is held stationary (and while the heated portions 252, 254 are at the hot working temperature and the second preselected temperature respectively), the second workpiece 226 may be moved axially, in the direction indicated by arrow “3B”, to urge the second heated portion 254 against the first heated portion 252. Shortly after the initial engagement, the second workpiece 226 is moved in the direction indicated by arrow “3B₁”, i.e., axially, to briefly relieve the pressure exerted against the first heated portion 252 by the second heated portion 254. However, it is preferred that the second heated portion 254 is not, by the movement in the direction indicated by arrow “3B₁”, fully disengaged from the first heated portion 252. Such axial engagement and relief of pressure may be repeated, to effect an oscillation.

In yet another embodiment, both of the workpieces 222, 226 may be subjected to axial oscillation, e.g., at the same time, or at substantially the same time.

In effect, in these embodiments, the relative axial movement (i.e., axial oscillation) of one or both of the workpieces 222, 226 while the heated portions are engaged causes the small part 231 of the first heated portion 252 to be mixed with the small part 233 of the second heated portion 254, at the atomic level, similar to the mixing or intermingling of materials believed to be achieved upon engagement of the first and second heated portions 252, 254 while one or both of the workpieces are rotating, as described above.

In yet another embodiment, the axial oscillation described above may be combined with the rotation and engagement of the first and second workpieces, for bonding the first and second workpieces together.

It will be understood that the extent of the parts 231, 233 as illustrated in FIG. 3C is exaggerated, for clarity of illustration. When the workpieces are bonded together, the small parts 231, 233 define a bonded zone “3Z” (FIG. 3C) across which the first and second workpieces 222, 226 are bonded together.

As illustrated in FIG. 3C, the first and second workpieces 222, 226 preferably are fused or bonded together to form an assembly 270.

In another embodiment illustrated in FIGS. 3D and 3E, a first workpiece 222′ preferably includes one or more grooves 260′ therein, and a second workpiece 226′ preferably includes one or more protruding elements 268′ that fit into the grooves 260′. Preferably, first and second heated portions 252′, 254′ of the first and second workpieces 222′, 226′ are heated to a hot working temperature of the metal of the first workpiece and to the second preselected temperature respectively, by the heating elements 246′ and the intermediate plate 236′, in substantially the same manner as described above.

In one embodiment, it is also preferred that one or both of the workpieces 222′, 226′ are rotated about their respective axes 224′, 228′. Preferably, one or both of the workpieces 222′, 226′ is moved toward the other (i.e., in the directions indicated by arrows “3A₂” and “3B₂” respectively), to engage the heated portions 252′, 254′ with each other. It will be understood that one or both of the workpieces 222′, 226′ preferably are rotating about their respective axes 224′, 228′ either before or after the heated portions 252′, 254′ are engaged with each other. When the heated portions 252′, 254′ are engaged with each other, the protruding elements 268′ preferably are engaged in the grooves 260′.

Preferably, the workpieces 222′, 226′ are bonded together, to form an assembly 270′, substantially in the same manner as the workpieces 222, 226 are bonded together, as described above.

Alternatively, the workpieces 222′, 226′ may be bonded together by utilizing axial oscillation, substantially as described above in connection with the workpieces 222, 226.

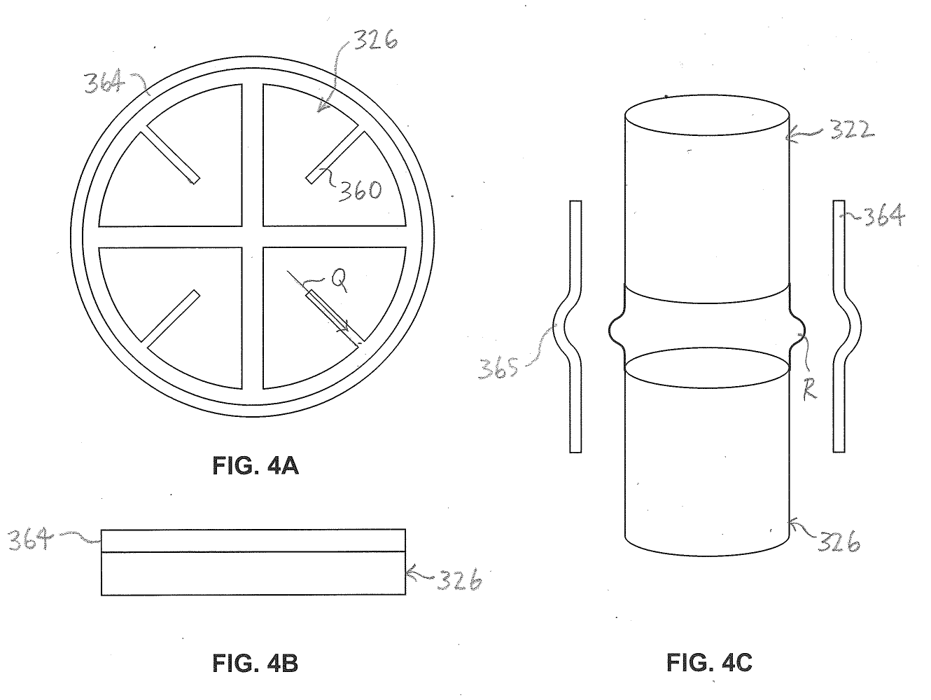

In another alternative embodiment, illustrated in FIGS. 4A-4C, the second workpiece 326 preferably includes grooves 360 formed to allow at least a part of the plastically deformable first heated portion (not shown) of the first workpiece 322 to be squeezed outwardly, away from a central region of the second workpiece 326. Because the workpieces 322, 326 are axially aligned when they are engaged with each other, the plastically deformable material may also be pushed outwardly from the central region.

Those skilled in the art would appreciate that, when the workpieces 322, 326 are engaged with each other, the plastically deformable material tends to be squeezed or driven generally radially outwardly, i.e., in the direction indicated by arrow “Q” in FIG. 4A. The grooves 360 are formed to receive the plastically deformed material therein.

It is also preferred that a retaining ring 364 is provided, to retain the plastically deformed first heated portion so that it is located between the first and second workpieces as it cools. In one embodiment, illustrated in FIG. 4C, the retaining ring may be formed to include a central region 365 formed for receiving any excess plastically deformed material. Some of the plastically deformable material may be allowed, by the central region 365, to form a bulge “R”.

It will be understood that, in FIG. 4C, the retaining ring 364 is shown spaced apart from the first and second workpieces 322, 326 for clarity of illustration. Also, the size of the central region 365 is exaggerated for clarity of illustration. Preferably, the extent to which the plastically deformable material is allowed to form the bulge “R” is limited.

In the prior art, the plastically deformed material that is deformed during a conventional friction welding process typically is unconstrained, and a relatively large protrusion of the material outwardly may result. The protrusion is due to the unconstrained flow of the plastically deformed material, during conventional friction welding, in a direction generally orthogonal to the direction in which the workpieces are urged together. In these circumstances (i.e., bonding workpieces using a conventional frictional welding process), a pronounced “fusion line” tends to develop between the workpieces. The prior art fusion line typically is generally orthogonal, or approximately orthogonal, to the direction in which the workpieces were pushed together. Those skilled in the art would appreciate that the workpieces tend not to be securely bonded together across the fusion line.

In the prior art, therefore, the products resulting from the workpieces that are joined together by conventional friction welding tend to fail along the fusion line. It is believed that, to the extent that the retaining ring 364 urges the plastically deformed material of the first heated portion against the second heated portion, a well-defined fusion line that marks the edge of the plastically deformable material (and which is thought to be a vulnerability in a conventional weld of metal to ceramic) does not develop. Due to this, the bond provided by the embodiment illustrated in FIGS. 4A-4C is believed to be stronger than conventional welds formed using conventional methods.

In another embodiment, illustrated in FIG. 4D, the retaining ring 364 preferably has an internal surface 367 that is curved outwardly relative to respective external surfaces “S₁”, “S₂” of the workpieces 322, 326. Due to the alignment of the internal surface 367 with the sides “S₁”, “S₂”, when the heated portions are at the hot working temperature and engaged, the plastically deformed material is urged inwardly (as indicated by arrows “T”), against itself, and against the second workpiece 326 by the retaining ring 364. However, the internal surface 367 preferably is formed to accommodate the bulge “R” of plastically deformed material. It is believed that, as a result, a well-defined fusion line does not develop when the retaining ring 364 us utilized, promoting better bonding between the first and second workpieces 322, 326.

It is also believed that the retaining ring 364 may be used in a conventional friction welding process, to minimize the risk of developing a well-defined fusion line.

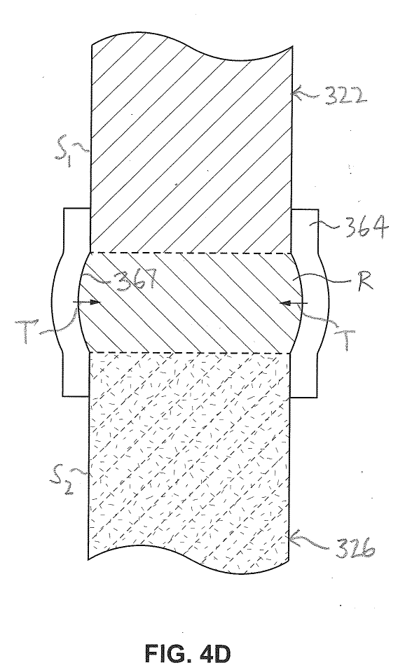

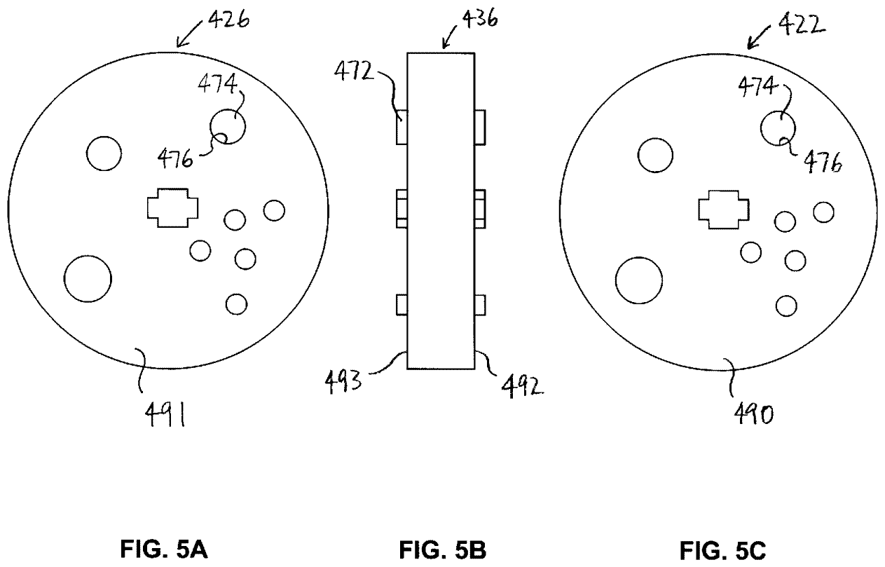

In another alternative embodiment, illustrated in FIGS. 5A-5C, the intermediate plate 436 preferably includes one or more projections 472 that are configured to fit into corresponding cavities 474 formed in one or both of the first and second workpieces 422, 426.

As illustrated in FIGS. 5A-5C, the cavities 474 may have any suitable shape. It will be understood that the respective projections 472 (FIG. 5B) are each formed and positioned to fit into the respective cavities 474.

The cavities 474 may have any suitable form. It will be understood that the various cavities 474 that are illustrated in FIGS. 5A-5C are exemplary.

It will be understood that first and second heated portions (not shown) of the first and second workpieces 422, 426 and the intermediate plate 436 preferably are heated to a hot working temperature and the second preselected temperature respectively by one or more heating elements that are omitted from FIGS. 5A-5C, for clarity of illustration.

In one embodiment, after the first and second heated portions and the intermediate plate 436 are heated as described above, the heating elements are removed, and the first and second workpieces and the intermediate plate 436 are pushed together, thereby inserting the projections 472 into the respective cavities 474.

Preferably, prior to heating, the workpieces 422, 426 and the intermediate plate 436 are positioned to align the projections 472 and the cavities 474. It will be understood that, in this embodiment, the first and second workpieces 422, 426 preferably are not rotated about their respective axes. Instead, once the workpieces 422, 426 and the plate 436 are heated to the hot working temperature, one or both of the workpieces preferably are moved axially (i.e., in the absence of rotation thereof) against the intermediate plate 436, and/or the intermediate plate 436 is axially moved against one or both of the workpieces, to position the projections 472 inside the respective cavities 474.

Preferably, the intermediate plate 436 is sufficiently heated by the heating elements (not shown) that the projections 472 are plastically deformable.

Once the projections 472 are inserted into the cavities 474, one or both of the first and second workpieces 422, 426 are engaged with the intermediate plate 436. Preferably, the projections 472 are formed for engagement with the walls 476 defining the respective cavities 474. It is believed that the projections 472, as they are pushed into the cavities 474, are engaged with the walls 476, and are therefore to an extent subject to shear.

As can be seen in FIGS. 5A and 5C, each of the first and second workpieces 422, 426 preferably includes a mating surface 490, 491 thereof, in which the cavities 474 are formed. Preferably, the intermediate plate 436 also includes first and second mating surfaces 492, 493 on opposite sides thereof (FIG. 5B). As can be seen in FIG. 5B, as illustrated, the projections 472 preferably extend from the first and second mating surfaces 492, 493.

It will be understood that, when the projections 472 extending from the first mating surface 492 are fully positioned in the cavities 474 in the first workpiece 422, the mating surface 490 and the first mating surface 492 preferably are substantially fully engaged with each other. Similarly, when the projections 472 that extend from the second mating surface 493 preferably are fully positioned in the cavities 474 in the second workpiece 426, the mating surface 491 and the second mating surface 493 preferably are substantially fully engaged with each other.

Those skilled in the art would appreciate that the respective mating surfaces may have any suitable complementary configurations.

In one embodiment, when the projections 472 are at the hot working temperature, the projections 472 preferably fit into their respective cavities 474 in an interference or friction fit with the result that the projections are, to an extent, subjected to shearing as they are inserted into the respective cavities.

It will be understood that the heated portions of the projections and, in the first workpiece, the heated portion of the walls, preferably are plastically deformable, at least in part. Preferably, the heated portions of the projections 472 that are inserted into the cavities of the second workpiece at least partially bond to the walls 476 of the cavities 474 in the second workpiece 426, and remain secured thereto upon cooling. Similarly, the heated portions of the projections that are inserted into the cavities of the first workpiece at least partially bond to the walls 476 of the cavities 474 in the first workpiece 422, and remain secured thereto upon cooling.

It is believed that small parts of the projections 472 and the walls of the cavities 474 are intermingled during the shearing that takes place as the projections 472 are inserted into the cavities 474.

It will also be understood that the first heated portion of the first workpiece and the projections 474 that extend from the first mating surface 492 may be heated to the hot working temperature, and subsequently engaged, at one time, and the second heated portion of the second workpiece 426 and the projections extending from the second mating surface 493 may be heated, and subsequently engaged, at another time. The second heated portion (and the projections 472 extending from the second mating surface 493) may be heated to a temperature other than the hot working temperature, e.g., the second preselected temperature.

In another embodiment, some or all of the cavities 474 may be formed in the intermediate plate 436, and some or all of the projections 472 may be located on one or both of the mating surfaces 490, 491 on the first and second workpieces.

It will be understood that, when the projections 474 are inserted into the cavities 472, one or more of the workpieces 422, 426 and the intermediate plate 436 may be subjected to axial oscillation.

It is believed that the relative axial movement (i.e., axial oscillation) of one or more of the workpieces 422, 426 and the intermediate plate while the projections 474 and heated portions of the workpieces are at the hot working temperature causes small parts of each projection and heated portion to be mixed or intermingled together. Upon cooling, the workpieces 422, 426 are bonded to the intermediate plate 436 therebetween.

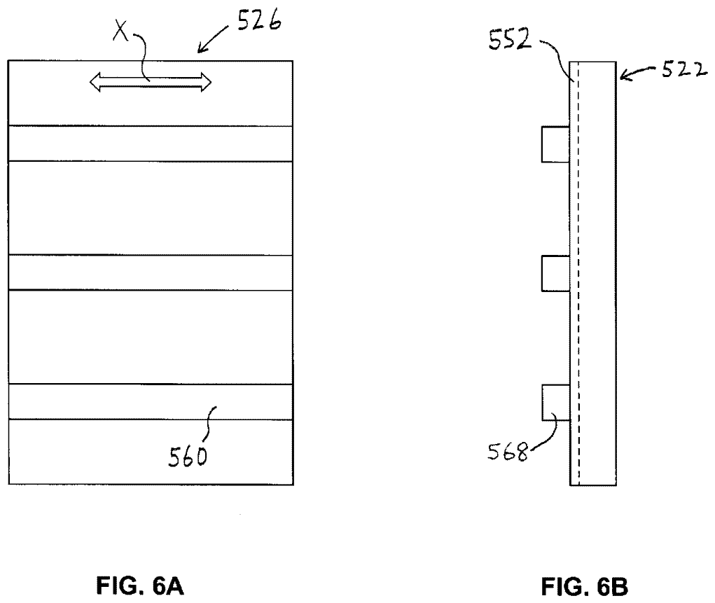

In another alternative embodiment, illustrated in FIGS. 6A and 6B, a first workpiece 522 has protruding elements 568 thereon, which substantially fit into respective grooves 560 in a second workpiece 526. It will be understood that the first and second workpieces 522, 526 are heated by one or more heating elements (not shown) and an intermediate plate (not shown) that is positioned between the second workpiece 526 and the heating elements. Preferably, a first heated portion 552 of the first workpiece 522 is heated to a hot working temperature. It will be understood that a second heated portion (not shown) of the second workpiece 526 is also heated to a second preselected temperature that may be equal to the hot working temperature. Next, the heating elements and the intermediate plate are removed.

Preferably, the protruding elements 568 are next inserted into the grooves 560, and one or both of the first and second workpieces 522, 526 are moved linearly (i.e., in the directions indicated by arrow “X”). Due to the configurations of the grooves 560 and the protruding elements 568, the engaged surface areas of the first and second workpieces 522, 526 are relatively large, in the embodiment illustrated. The larger engaged surface areas promote bonding of the first and second workpieces 522, 526 with each other. Preferably, the first heated portion 552 at least partially adheres to the second heated portion and remains secured thereto upon cooling.

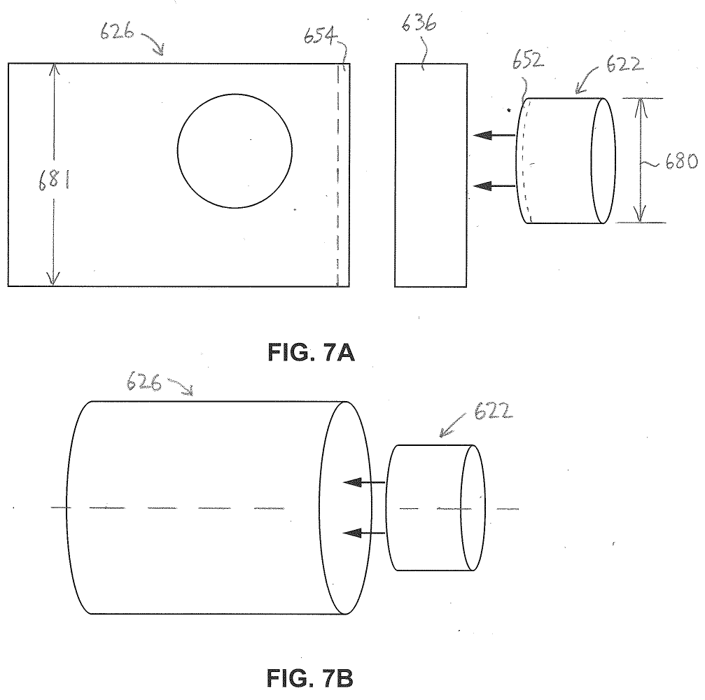

In another alternative embodiment, illustrated in FIGS. 7A and 7B, a first workpiece 622 preferably has a smaller diameter 680 than a diameter 681 of a second workpiece 626.

It will be understood that a first heated portion 652 is heated to a hot working temperature by one or more heating elements (not shown in FIG. 7A). Preferably, a second heated portion 654 is heated to the second preselected temperature by an intermediate plate 636, which is positioned between the heating element and the second workpiece 626.

Next, the heating element and the intermediate plate 636 are removed from their locations between the workpieces 622, 626, and one or both of the workpieces 622, 626 are rotated about their respective axes 624, 628 (FIG. 7B). While the first and second heated portions are at the hot working temperature and the second preselected temperature respectively, and while the workpieces are rotating about their respective axes, the first and second surfaces of the workpieces 622, 626 are engaged with each other.

Those skilled in the art would appreciate that, where the second workpiece 626 is at least partially made of a ceramic material, the heated workpiece may tend to fracture or chip at its engaged part, if the entire surface 632 is engaged by a surface of the first workpiece. This is believed to occur because of the strain to which the second workpiece is subjected at its outer circumference, and also because the outer circumference of the second workpiece is unsupported.

Also, when the workpieces 622, 626 are rotated about their respective central axes, the parts of the surfaces that are proximal to the outer circumferences of the workpieces are rotating faster than parts thereof that are at or proximal to the respective central axes.

Accordingly, in the embodiment illustrated in FIGS. 7A and 7B, the second workpiece 626 is larger, i.e., the diameter 681 is larger than the diameter 680 of the first workpiece 622. It is believed that, with this arrangement, the surface of the second workpiece is less likely to fracture at the outer circumference. A retaining ring may be utilized, to urge plastically deformed material inwardly, so that a well-defined fusion line does not develop.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A method of joining a first workpiece including a first material with a first thermal conductivity and a second workpiece including a second material with a second thermal conductivity that is less than the first thermal conductivity, the method comprising:
(a) locating the first and second workpieces to position respective first and second surfaces thereof spaced apart to define a primary gap therebetween;
(b) locating an intermediate plate in the primary gap to define a first gap between a first side of the intermediate plate spaced apart from the first surface by a first predetermined distance, and a second gap between a second side of the intermediate plate that is spaced apart from the second surface of the second workpiece, the intermediate plate comprising a third material with a third thermal conductivity that is less than or equal to the first thermal conductivity;
(c) locating at least one heating element in the first gap, said at least one heating element being positioned a first preselected distance apart from the first surface, and a second preselected distance apart from the first side of the intermediate plate;
(d) energizing said at least one heating element, to heat a first heated portion of the first workpiece in an inert atmosphere to a hot working temperature at which the first heated portion is plastically deformable, and to heat the intermediate plate to a first preselected temperature at which the heated intermediate plate heats a second heated portion of the second workpiece in the inert atmosphere to a second preselected temperature;
(e) removing the intermediate plate and said at least one heating element from the primary gap;
(f) while the first heated portion is at the hot working temperature and the second heated portion is at the second preselected temperature, subjecting one or both of the first and second workpieces to a translocation motion, to engage the first and second surfaces with each other; and
(g) while the first heated portion is at the hot working temperature and the second heated portion is at the second preselected temperature, and while the first and second surfaces are engaged, subjecting one or both of the first and second workpieces to an engagement motion, in which one or both of the first and second workpieces moves relative to the other, for at least partially subjecting the first heated portion to shearing and to adhere the first heated portion to the second heated portion, to bond the first and second workpieces together.

2. The method according to claim 1 in which:
the first, second, and third materials have respective first, second, and third melting points;
the first and third melting points are both less than the second melting point; and
the first melting point is less than the second melting point.

3. The method according to claim 1 in which:
the first workpiece defines a first axis thereof;
the second workpiece defines a second axis thereof; and
the engagement motion comprises rotation of one or both of the first and second workpieces about the respective axes thereof.

4. The method according to claim 3 in which the first and second workpieces are positioned coaxially.

5. The method according to claim 1 in which:
the first workpiece defines a first axis thereof;
the second workpiece defines a second axis thereof; and
the engagement motion comprises oscillation of one or both of the first and second workpieces in an axial direction parallel to the first and second axes.

6. The method according to claim 1 in which said at least one heating element heats the first heated portion by induction.

7. The method according to claim 1 in which said at least one heating element heats the intermediate plate by induction.

8. The method according to claim 1 in which the second heated portion is heated to the second preselected temperature by radiation of heat energy from the intermediate plate.

9. The method according to claim 1 in which the intermediate plate comprises an intermediate plate material with a third thermal conductivity that is equal to or greater than the second thermal conductivity.

10. A method of joining a first workpiece including a first material with a first thermal conductivity and a second workpiece including a second material with a second thermal conductivity that is less than the first thermal conductivity, the method comprising:
(a) locating the first and second workpieces to position respective first and second surfaces thereof spaced apart to define a primary gap therebetween;
(b) locating an intermediate plate in the primary gap to define a first gap between a first side of the intermediate plate spaced apart from the first surface by a first predetermined distance, and a second gap between a second side of the intermediate plate that is spaced apart from the second surface of the second workpiece, the intermediate plate comprising a third material with a third thermal conductivity that is less than or equal to the first thermal conductivity;
(c) locating at least one heating element in the first gap, said at least one heating element being positioned a first preselected distance apart from the first surface, and a second preselected distance apart from the first side of the intermediate plate;
(d) energizing said at least one heating element, to heat a first heated portion of the first workpiece in an inert atmosphere to a first hot working temperature at which the first heated portion is plastically deformable, and to heat the intermediate plate to a first preselected temperature in which the heated intermediate plate heats a second heated portion of the second workpiece in the inert atmosphere to a second preselected temperature;
(e) removing the intermediate plate and said at least one heating element from the primary gap;
(f) while the first and the second heated portions are at the hot working temperature and the second preselected temperature respectively, subjecting one or both of the first and second workpieces to an engagement motion, in which one or both of the first and second workpieces are moved relative to the other;
(g) while the first and second heated portions are at the hot working temperature and the second preselected temperature respectively, subjecting one or both of the first and second workpieces to a translocation motion, to engage the first and second surfaces with each other; and
(h) while the first and second heated portions are at the hot working temperature and the second preselected temperature respectively, and while the first and second surfaces are engaged, subjecting one or both of the first and second workpieces to the engagement motion, for at least partially subjecting the first heated portion to shearing and to adhere the first heated portion to the second heated portion, to bond the first and second workpieces together.

11. The method according to claim 10 in which:
the first, second, and third materials have respective first, second, and third melting points;
the first and third melting points are both less than the second melting point; and
the first melting point is less than the second melting point.

12. The method according to claim 10 in which:
the first workpiece defines a first axis thereof;
the second workpiece defines a second axis thereof; and
the engagement motion comprises rotation of one or both of the first and second workpieces about the axes thereof.

13. The method according to claim 12 in which the first and second workpieces are positioned coaxially.

14. The method according to claim 10 in which:
the first workpiece defines a first axis thereof;
the second workpiece defines a second axis thereof; and
the engagement motion comprises oscillation of one or both of the first and second workpieces in an axial direction parallel to the first and second axis.

15. The method according to claim 10 in which said at least one heating element heats the first heated portion by induction.

16. The method according to claim 10 in which said at least one heating element heats the intermediate plate by induction.

17. The method according to claim 10 in which the intermediate plate heats the second heated portion by radiation.

18. The method according to claim 10 in which the intermediate plate comprises an intermediate plate material with a third thermal conductivity that is equal to or greater than the second thermal conductivity.
